(19) United States
(12) Patent Application Publication
(10) Pub. No.: US 2017/0035042 A1
(43) Pub. Date: Feb. 9, 2017

(54) SMALL ANIMAL TRAP

(71) Applicants: Eiran BEN-DASHAN, Los Gatos, CA (US); David M. EARLE, Watsonville, CA (US)

(72) Inventors: Eiran BEN-DASHAN, Los Gatos, CA (US); David M. EARLE, Watsonville, CA (US)

(21) Appl. No.: 15/227,896

(22) Filed: Aug. 3, 2016

Related U.S. Application Data
(60) Provisional application No. 62/200,361, filed on Aug. 3, 2015.

(51) Int. Cl. A01M 23/24; G08B 21/18; A01M 99/00

(52) U.S. Cl. CPC A01M 23/24; A01M 99/00; G08B 21/18

(57) ABSTRACT

A small animal trap may include an actuator portion coupled to a trapping portion insertable into a burrow or tunnel of the target animal. The trapping portion may include an extension guide and a transversely-extending capture mechanism, such that the extension guide extends along a length of the tunnel and the capture mechanism extends across a width of the tunnel and generally conforms to the tunnel wall. A wireless communication system may be included to inform a remote user of an actuation state of the trap. An array of such traps may be deployed.

### CROSS-REFERENCES

This application claims the benefit under 35 U.S.C. §119(e) of the priority of U.S. Provisional Patent Application Ser. No. 62/200,361, filed Aug. 3, 2015, the entirety of which is hereby incorporated by reference for all purposes.

### FIELD

This disclosure relates to systems and methods for trapping small animals. More specifically, the disclosed embodiments relate to devices and methods for trapping burrowing animals, such as gophers and other rodents.

Introduction

Small animals, such as gophers, typically live in underground burrows and tunnel systems. Construction and maintenance of these living quarters disrupts the landscape, damaging lawns, crops, and other otherwise-valuable real estate. Accordingly, animals such as burrowing mammals (e.g., gophers) are classified as pests. Elimination of these pests has been an ongoing activity of homeowners and farmers for centuries. Various traps have been devised over the years, both live and lethal. These traps tend to be dangerous to operate and/or difficult to monitor.

### SUMMARY

The present disclosure provides systems, apparatuses, and methods relating to improved small animal traps.

In some embodiments, a small animal trap may include a trapping portion including a capture mechanism configured to capture a target animal; an actuator portion coupled to the trapping portion and configured to actuate the capture mechanism; and a wireless transmitter configured to communicate an actuation state of the capture mechanism to a receiving device.

In some embodiments, a small animal trap may include an actuator portion including a biasing mechanism having a connector; a trapping portion coupled to the actuator portion, the trapping portion including an extension guide having a filament running therethrough, the filament being coupled to the connector of the biasing mechanism at a proximal end and forming a constrictable loop at a distal end; and a reorientation assembly including a pair of curved tubes coaxial with the filament and configured to reorient the filament such that the loop is generally transverse to the extension guide.

In some embodiments, a small animal trap may include an actuator portion including a spring coupled to a piston disposed in a substantially cylindrical housing; and a trapping portion operatively coupled to the piston of the actuator portion, the trapping portion including an extension guide and a capture mechanism extending at a transverse angle from the extension guide, such that the trapping portion is configured to extend along a tunnel with the capture mechanism extending at least partially across the tunnel; the capture mechanism being operable between a cocked configuration, in which the capture mechanism is expanded to substantially conform to a wall of the tunnel, and a triggered configuration, in which the capture mechanism is constricted by the actuator portion.

In some embodiments, a method for trapping a small animal may include inserting a trapping portion of a small animal trap into a tunnel and along a length of the tunnel, the trapping portion including an extension guide and a capture mechanism extending transversely from the extension guide; expanding the capture mechanism of the trapping portion, such that the capture mechanism extends at least partially across the tunnel and conforms to the wall of the tunnel; and arming the small animal trap by cocking an actuator portion coupled to the trapping portion.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic diagram of an illustrative small animal trap in accordance with aspects of the present disclosure.

FIG. 2 is an isometric view of an illustrative small animal trap in accordance with aspects of the present disclosure.

FIG. 3 is a top plan view of the trap of FIG. 2, in a cocked or armed configuration.

FIG. 4 is a top plan view of the trap of FIG. 2, in a triggered or released configuration.

FIG. 5 is a side elevation view of the trap of FIG. 2, in a cocked or armed configuration.

FIG. 6 is a side elevation view of the trap of FIG. 2, in a triggered or released configuration.

FIG. 7 is an exploded view of a spring connector portion of the trap of FIG. 2.

FIG. 8 is a partial view of a coupling assembly portion of the trap of FIG. 2.

FIG. 9 is a schematic diagram of an array of illustrative small animal traps according to the present teachings.

FIG. 10 is a flow chart depicting steps of an illustrative method for trapping small animals.

### DESCRIPTION

Various aspects and examples of a small animal trap, as well as related methods, are described below and illustrated in the associated drawings. Unless otherwise specified, a small animal trap according to the present teachings and/or its various components may, but are not required to, contain at least one of the structure, components, functionality, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

Definitions

The following definitions apply herein, unless otherwise indicated.

“Substantially” means to be essentially conforming to the particular dimension, range, shape, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

Overview

In general, a small animal trap in accordance with aspects of the present disclosure may include an actuator portion coupled to a trapping portion comprising a capture mechanism (e.g., a noose or jaw). In use, the trapping portion may be placed into an existing tunnel, with the actuator portion remaining above ground. Setting the trap includes inserting and expanding the trapping (e.g., noose) portion within the tunnel, such that an animal traveling through the tunnel will also travel through the opening of the noose. In examples having a noose, the noose is formed by a loop of wire, cable, or other filament having sufficient stiffness to allow the loop to retain a noose-like shape within the tunnel. The cable loop extends from the actuator through a set of linear extension guides, and then through a reorientation assembly. The extension guides may be somewhat flexible in a radial direction, e.g., to allow the extension guides to follow contours of the tunnel. The reorientation assembly includes a pair of rigid or semi-rigid tubes that the cable passes through. These tubes are shaped to cause the expanded opening of the noose to form a substantially right angle with the rest of the cable as it extends along the tunnel.

The trapping portion (e.g., noose) is expanded and retracted by the actuator portion, which includes a spring or other biasing mechanism. The cable is operatively connected to the spring, which is biased toward a retracted position. Overcoming the bias of the spring causes the noose to expand. Conversely, releasing the spring tension causes the spring to quickly retract the cable, thereby forcibly collapsing or constricting the noose and impinging upon the target animal. The noose may be expandable, for example, to the diameter of the tunnel or hole in which it is placed. In some examples, the trapping portion may be inserted into the tunnel and expanded by hand, then connected to the actuator portion.

The spring may be held in the cocked position (i.e., with the noose expanded) by a latch mechanism (also referred to as a release mechanism). The latch mechanism may include a mechanical stop that is actuated by an electrical solenoid. The solenoid may be controlled by an electronic triggering sensor placed adjacent to the noose or jaw end of the trapping portion. This sensor may include any suitable electronic sensor, such as a proximity sensor, electro-mechanical sensor, heat sensor, motion sensor, and the like, or any combination thereof. Activating the sensor immediately triggers the solenoid, removing the mechanical stop, and releases the spring tension. This results in a rapid retraction of the cable, thereby rapidly reducing the diameter of the noose and trapping the animal.

Accordingly, an animal traveling through the tunnel will pass into the expanded noose. The sensor may be disposed such that the front end of the animal will activate the sensor, while the body of the animal remains within the circumference of the noose. Activating the sensor will cause the noose to rapidly retract, killing the animal. Depending on placement of the sensor, this may work in similar fashion with animals traveling in an opposite direction. Multiple sensors and/or nooses may be employed to add functionality.

The trapping portion of the device may be mechanically separable (e.g., releasable or removable) from the actuator portion. This may be advantageous in that the trapping portion can become damaged and dirty, and could be disposable. In addition, as described above, the trapping portion may be inserted into the tunnel by hand, and the noose expanded manually until the user feels that the diameter has reached the outer perimeter of the tunnel. The actuator portion could then be attached to the cable.

A single trap may be deployed (e.g., by a homeowner). In some examples, a plurality of such traps may be deployed, such as by a farmer having one or more fields infested by burrowing rodents. Each trap may include a wireless communication device, such that an actuation state (e.g., cocked or tripped) and/or location of the trap may be communicated to the user. For example, communication with the user may be through a central communication station or via a mobile application (e.g., a smart phone app), such that the user will know which traps need to be checked and/or emptied, rather than having to physically examine each trap on a regular basis. In some examples, the plurality of traps may form or be part of a device network. In some examples, a trap may communicate directly with a receiving device (e.g., a portable electronic device), in a point-to-point fashion. Electrical components of the trap may be powered by a portable power supply, such as a battery or set of batteries, and may be rechargeable. In some examples, solar cells may be included to charge the portable power supply.

### EXAMPLES, COMPONENTS, AND ALTERNATIVES

The following sections describe selected aspects of exemplary small animal traps as well as related systems and/or methods. The examples in these sections are intended for illustration and should not be interpreted as limiting the entire scope of the present disclosure. Each section may include one or more distinct embodiments or examples, and/or contextual or related information, function, and/or structure.

Schematic Diagram

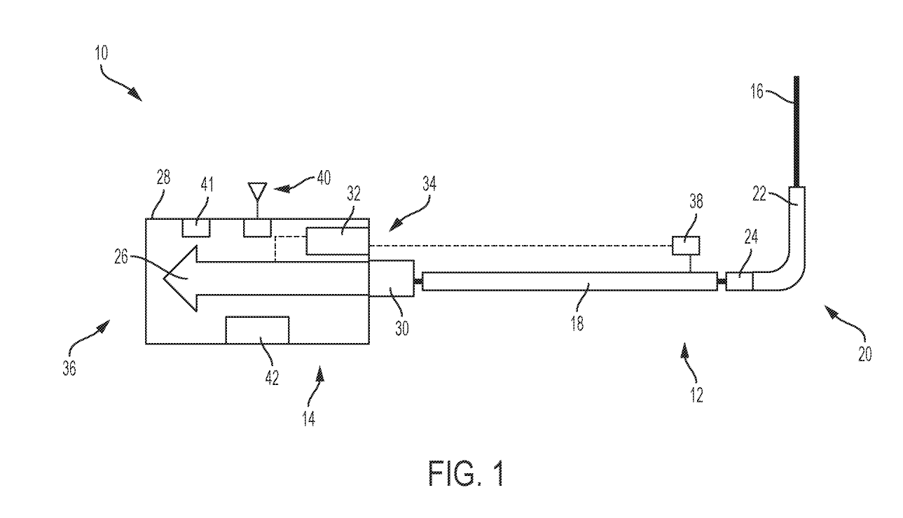

As shown in FIG. 1, this section describes a trap 10 having a removable actuator and a reorientation assembly. Trap 10 is an example of the trap generally described above.

FIG. 1 is a schematic diagram, showing relationships between various components of trap 10. As shown in FIG. 1, trap 10 may include a trapping portion 12 operatively connected to an actuator portion 14. In some examples, trapping portion 12 and actuator portion 13 may be permanently connected. In some examples, trapping portion 12 may be removably connected to actuator portion 14. In other words, trapping portion 12 may be configured to be both easily securable to and easily removable/separable from actuator portion 14. Attachment and/or removal may be performed by hand and/or using one or more tools. Use of the term “removable” (and the like) in this context is not intended to encompass destructive methods of “removal,” such as cutting or breaking of the device.

Trapping portion 12 may include any suitable capture mechanism and/or trapping elements configured to extend across and conform at least in part to the inner diameter and contours of a hole, tunnel, or burrow of the animal to be trapped. The capture mechanism may extend generally in a direction transverse (e.g., orthogonal) to a long axis of the tunnel. For example, trapping portion 12 may include a capture mechanism in the form of a pair of jaws configured to hug the wall(s) of the tunnel. In other examples, trapping portion 12 may include a capture mechanism in the form of a noose configured to generally conform to the tunnel's lateral perimeter (e.g., floor, ceiling, walls).

Accordingly, trapping portion 12 may include a filament 16, also referred to as a line, wire, and/or cable. Filament 16 may include any suitable thread, wire, fiber, or other elongate, flexible member capable of being shaped into a noose-like loop and holding that shape. Filament 16 may include a monofilament, a braided cable, and/or the like, or any combination of these. In some examples, filament 16 may be similar to a brake cable on a bicycle. Filament 16 may comprise stainless steel, nylon, polyethylene, and/or any other suitable materials. The two terminal ends of the filament may be secured to the actuator portion, forming a proximal end of the noose. A distal end, opposite the proximal end, includes the constrictable loop of the noose. In some examples, a single terminal end of the filament is secured in the actuator, with the other end slidably attached to the body of the filament, as in a slipknot (or the like).

Trapping portion 12 may include one or more components configured to support and shape filament 16. For example, trapping portion 12 may include an elongate linear extension guide portion 18 and a reorientation assembly 20. Linear extension guide portion 18 may include one or more extension guides through which filament 16 extends. Each extension guide may include a hollow tube (also referred to as a tubular housing) configured to coaxially house a portion of the filament. Guide portion 18 may be rigid, semi-rigid, or flexible. Among other functions, the guide portion is configured to allow extension of the filament into and/or along a linear or curvilinear path, such as through a tunnel or burrow. Accordingly, guide portion 18 may be less flexible than filament 16. Guide portion 18 may comprise rugged or toughened materials configured to withstand an underground environment. Filament 16 may be axially slidable within the extension guides of the guide portion, such that the filament may be extended and retracted through the guides.

Reorientation assembly 20 may include any suitable devices and/or components configured to orient the terminal loop of filament 16 transverse to extension guide portion 18 (e.g., substantially orthogonal or normal to extension guide portion 18). In other words, the loop of noose portion 12 may be shaped to form an oblique or transverse angle (e.g., a roughly 90-degree angle) with the overall long axis of trap 10. Accordingly, the cable loop assembly of the noose may be extendable into a tunnel or hole such that the extension portion runs generally parallel to the long axis of the tunnel, and a distal end of the cable loop terminates in a noose that is formed generally perpendicular to the long axis of the tunnel. In this manner, the trap may be extended into and/or along a tunnel axis, while the noose generally extends across the tunnel and follows or conforms to the inner circumference of the tunnel.

Reorientation assembly 20 may include a pair of curved or shaped tubes 22. Each tube may coaxially house a portion of filament 16, such that the curvature of the tubes guides the loop of the filament into a transverse orientation. To allow the loop of the noose to expand and contract, tubes 22 may be pivotable with respect to the linear guide portion, such that the distal ends of the curved tubes can pivot toward and away from each other. In some examples, a connector block 24 may be used, such that guide portion 18 is secured to a first end of the block and tubes 22 are pivotably or rotatably connected to a second end of the block. In some examples, some or all of the guide portion is rotatable with the tubes, and/or the tubes are rotatably connected to the guide portion directly. Block 24 and/or any other suitable component may be utilized to hold a lower end of the filament loop closed. In other words, lower ends of tubes 22 may be held adjacent to each other, such that the loop of the noose does not include any substantial opening or exit in a radial direction.

Actuator portion 14 may be operatively connected to trapping portion 12, as described above, permanently or removably. Actuator portion 14 may include a biasing mechanism 26 enclosed in a housing 28, connectable to trapping portion 12 at a first end by a connector portion 30, and releasably latchable by a release mechanism 32. Biasing mechanism 26 may include any suitable device or structure configured to bias the filament attachment of connector portion 30 away from a first end 34 toward a second end 36. For example, biasing mechanism 26 may include a spring-loaded reel, a motorized retractor, and/or an elastic device such as a compression spring, a torsion spring, a tension spring, or the like, or any combination of these. Biasing mechanism 26 may have significant potential energy when in a cocked state, such that triggering of the biasing mechanism releases the potential energy and converts it to kinetic energy that quickly relocates the filament.

Connector portion 30 may include any suitable connection mechanism configured to releasably (or permanently) connect trapping portion 12 to first end 34 of actuator portion 14. Connector portion 30 may include separate connections or attachments for linear guide portion 18 and for filament 16. For example, linear guide portion 18 may connect to housing 28, and filament 16 may connect to biasing mechanism 26.

Latch mechanism 32 (also referred to as a release mechanism or latch/release mechanism) may include any suitable latching device configured to releasably retain biasing mechanism 26 in a cocked state. For example, latch/release mechanism 32 may include a solenoid-controlled mechanical stop. In some examples, latch/release mechanism 32 may include a clamp, a stop, a latch, a grabber, a hook, a trigger and/or the like, or any combination of these. In some examples, latch/release mechanism 32 may include an electrical switch or connector.

Filament 16 may be retracted into housing 28 by action of the biasing mechanism (e.g., spring) of actuator portion 14. Linear guide portion 18 and shaped tubes 22 are substantially rigid in the axial dimension. Accordingly, retraction of filament 16 will cause the filament to pass through the linear guides, effectively reducing the diameter of the loop at the terminal end of the noose. In other words, the noose will be tightened. Triggering of the actuator, therefore, causes the connected noose to retract such that an animal positioned therein will be trapped and/or killed by the noose.

Such triggering of latch/release mechanism 32 may be caused by a proximity sensor 38 in communication with the mechanism, as indicated in FIG. 1. Proximity sensor 38 may include any suitable switch or sensor configured to indicate the presence of an object. For example, a pressure switch, optical switch, contact plate, heat sensor, tripwire, and/or any other suitable sensor may be used. The sensor may be placed adjacent to linear guide portion 18, such that an animal passing through the noose in the direction of the actuator will trip the sensor while the body of the animal is still within the loop of the noose.

Trap 10 may include a communication device 40 configured to provide wireless communication with a base station or other receiver (e.g., as part of a network and/or with a handheld device, or the like). Communication device 40 may include a processor and an antenna. In some examples, communication device 40 may be configured to indicate a geographical position and/or one or more actuation states of trap 10, such as “set” or “tripped” or “malfunction.” Such indication(s) may be sent to a receiver. For example, indications of position or state may be provided by communication device 40 directly or over a cellular or other wireless network, e.g., to a smartphone or other computer-based device.

The actuation state of trap 10 may be determined by any suitable method. For example, the processor of communication device 40 may be in communication with sensor 38, latch mechanism 32, and/or an actuator position sensor 41, such that the processor is informed when the actuation state changes. Actuator position sensor 41 may include any suitable sensor or combination of sensors configured to detect the physical position of a portion of biasing mechanism 26.

Actuation state may be determined, for example, when sensor 38 signals the processor of communication device 40 that sensor 38 has been activated by a target animal, indicating that the trap has been triggered or tripped. In some examples, latch mechanism 32 may communicate a signal to the processor that the latch mechanism is engaged, or has been released, e.g., based on a status of a solenoid actuator of the latch. In some examples, actuator position sensor 41 may sense whether the actuator is in a cocked position or a released position. In some examples, a combination of such signals may be used to determine whether the trap is set or tripped, and/or whether a malfunction has occurred (e.g., if sensor 38 has been activated but repositioning of the actuator has not been detected).

Trap 10 may include one or more power supplies 42 configured to provide electrical and/or stored mechanical power to various components, such as latch/release mechanism 32 and/or communication device 40. Power supplies 42 may include one or more standard batteries, a capacitor, an ultra-capacitor, or the like, or any combination of these. Power supplies 42 may further include a mechanism for recharging such power supplies, such as a solar cell.

Illustrative Small Animal Trap

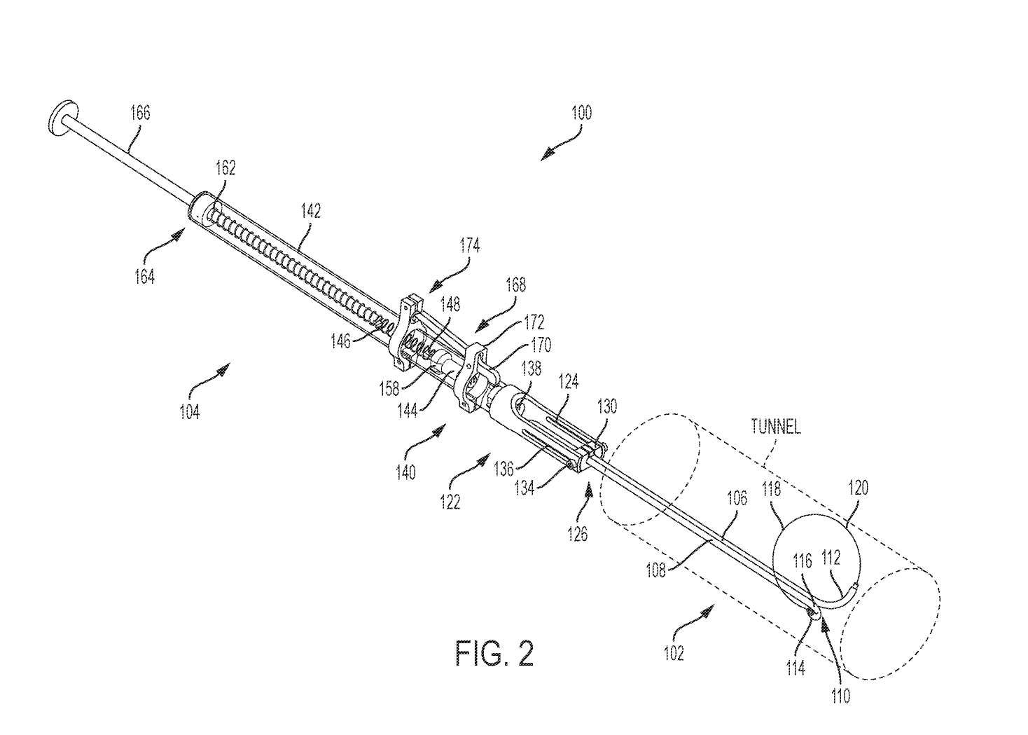

As shown in FIGS. 2-8, this section describes an illustrative small animal trap 100 according to the present teachings. Trap 100 is an example of trap 10, described above. Accordingly, similar components may be labeled with similar reference numbers.

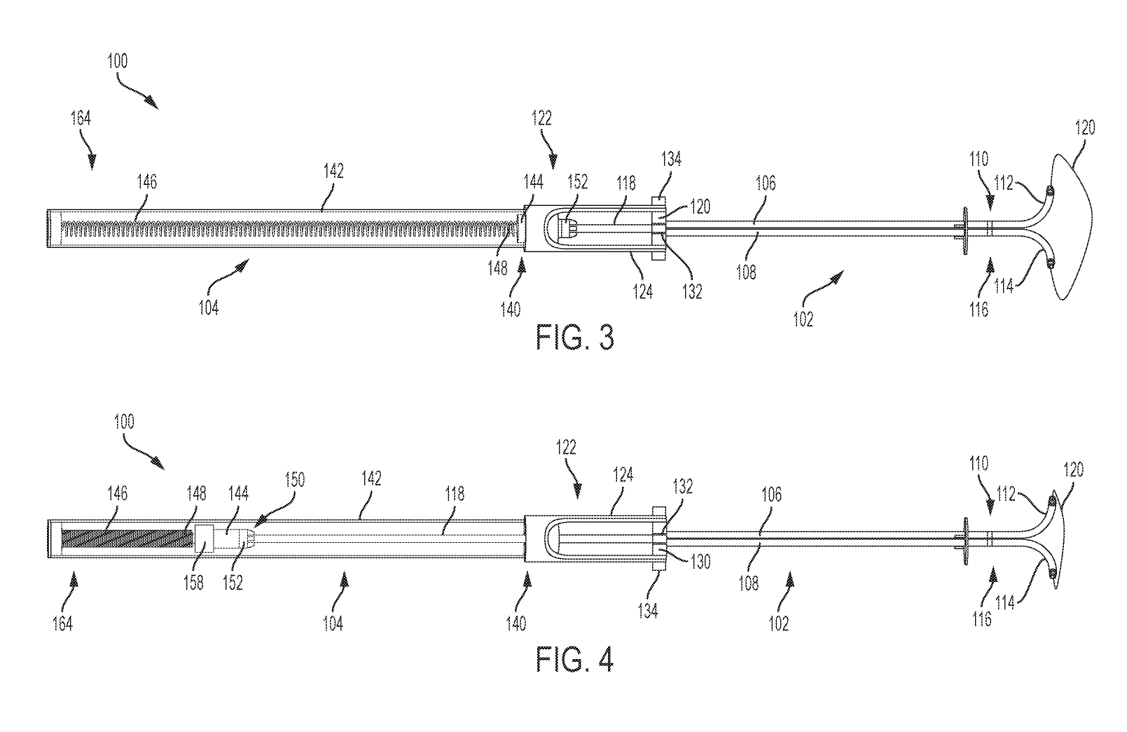

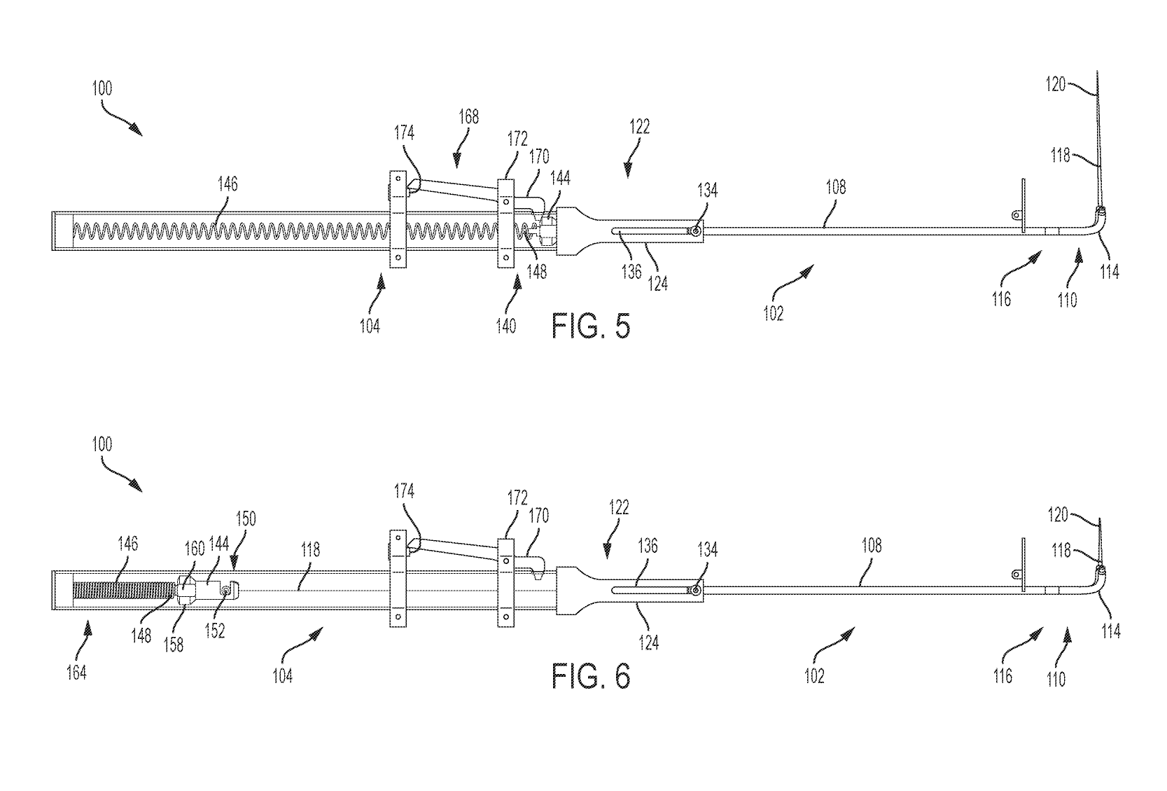

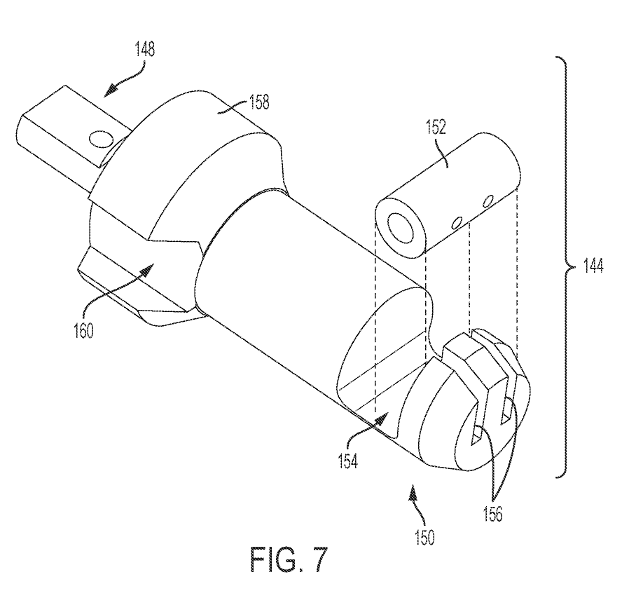

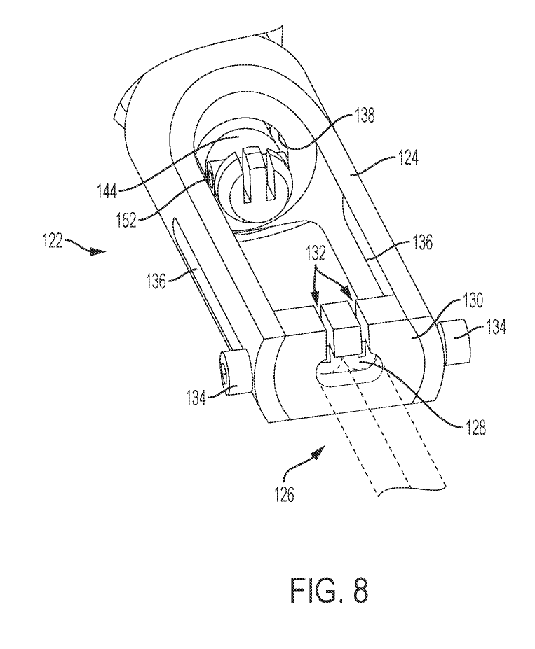

FIG. 2 is an isometric view of trap 100, while FIGS. 3-4 show overhead plan views and FIGS. 5-6 show side elevation views of the trap. In FIGS. 2-6, a housing of the actuator portion is depicted in semi-transparent fashion, such that internal components are made visible. FIGS. 7 and 8 are isometric views of portions of the trap, to illustrate selected aspects. FIGS. 3 and 5 show the trap in a cocked state, and FIGS. 4 and 6 show the trap in a released state. The cocked state may be referred to as a set, ready, expanded, and/or armed state or configuration. The released state may be referred to as a tripped, unarmed, unset, and/or retracted state or configuration. For clarity, selected components may be absent in some views. Trap 100 may include any or all components and functionality described above, with respect to trap 10, whether or not shown in any particular drawing.

As shown in FIGS. 7-18, trap 100 includes a trapping portion 102 operatively connected to an actuator portion 104. Trapping portion 102 includes a pair of linear guide portions 106, 108 (e.g., tubes) and a reorientation assembly 110. Linear guide portions 106 and 108 may include any suitable tubes configured to receive a cable slidingly therethrough, while being substantially rigid in a lengthwise or axial dimension. Guide portions 106 and 108 may be elastically pliable or bendable in a transverse direction, or in some examples may be inelastically pliable. This axial rigidity and non-axial pliability facilitates guidance of the flexible cable through a tunnel to place the noose end in a desired location.

Reorientation assembly 110 includes a pair of rigid, curvilinear (i.e., curved) tubes 112, 114 coupled (e.g., pivotably) to guide portions 106 and 108 respectively, and a coupling device or bracket 116. Bracket 116 may include any suitable structure configured to constrain the noose end of trapping portion 102, such that the proximal ends of the shaped tubes are held adjacent to each other. In some examples, bracket 116 includes a block, through which or to which the guide portions and reorientation assembly are attached. In some examples, bracket 116 is a structure that simply holds the two guides and/or the two reorientation tubes close together. As shown in FIG. 2, a connected pair of tube subsections may be used. In some examples, bracket 116 is not a separate component. Instead, for example, the ends of guide portions 106 and 108 may be connected to each other directly.

Tubes 112 and 114 include rigid, curvilinear structures configured to guide a cable 118 in a direction transverse to its original orientation. For example, tubes 112 and 114 may be configured to reorient cable 118 by approximately 90 degrees. As mentioned above, the distal ends of tubes 112 and 114 may pivot toward and away from each other to further facilitate retraction and expansion of the noose loop. In some examples, pivoting may be biased in either the outward or inward direction. For example, tubes 112 and 114 may be biased to pivot away from each other, to facilitate spreading of the lower portion of the noose loop against the tunnel wall or floor.

Cable 118 runs coaxially through the guides and reorientation assembly tubes, forming a terminal or distal loop 120. As described above, loop 120 may be expanded and contracted by pushing or pulling on terminal end(s) of the cable, respectively. In some embodiments, the loop may be expanded to fit an interior contour of an underground feature, e.g., by hand. Actuator portion 104 may be operatively connected to cable 118, such that the actuator may be triggered to forcibly retract or contract the cable, i.e., shrinking loop 120, as described further below.

Trapping portion 102 is coupled to actuator portion 104 at a coupling assembly 122 of the actuator. Coupling assembly 122 includes a hoop-shaped frame 124 accommodating a plurality of connectors. For example, a pair of guide connectors 126 include recesses 128 in an end portion 130 of frame 124, with each recess configured to receive an end portion of one extension guide. Each recess 128 is effectively a blind hole with respect to the extension guide, and does not pass through the end portion. Guide connectors 126 each also include a narrow slot 132 or opening passing through the end portion of the frame, such that cable 118 can pass freely through the frame with the extension guides seated in blind recesses 128. End portion 130 may be unitary with frame 124, or may be connected to frame 124, such as by a pair of bolts 134. In some examples, frame 124 may include lateral channels or slots 136, through which bolts 134 may pass. Slots 136 may facilitate adjustable mounting of end portion 130 relative to the remainder of frame 124. Coupling assembly 122 is shown in greater detail in FIG. 8.

Actuator portion 104 includes an opening 138 in a first end 140 of a housing 142 of the actuator portion. Housing 142 may include any suitable structure configured to enclose the actuator spring and guide the actuator spring connector (described below), while providing a safety barrier for a user operating the trap. In this example, housing 142 comprises a substantially cylindrical tube. Housings having other suitable shapes and sizes may be utilized.

Opening 138 is sized and configured to allow a connector portion 144 of an actuator spring 146 to pass or protrude therethrough, facilitating connection and/or disconnection of cable 118 with respect to connector portion 144. In this example, actuator spring 146 is a tension spring. The spring is depicted in the drawings in a fully extended or cocked position (see, e.g., FIG. 5) and in a fully retracted or released position (see, e.g., FIG. 6).

As best seen in the exploded view of FIG. 7, connector portion 144 is a two-piece connector secured to the movable end of actuator spring 146. Connector portion 144 includes an attachment end 148 for attaching the connector to the spring, and a hook end 150 for attaching cable 118 to the connector portion. A dowel 152 or bead portion may be inserted into a mouth or recess 154 of hook end 150 and axially retained therein. Dowel 152 is affixed to the terminal ends of cable 118. Accordingly, hooking the dowel or bead into connector portion 144 effectively attaches cable 118 to the connector. Force is placed on the cable in an axial direction during operation. Accordingly, disconnecting the cable from connector 144 of spring 146 may be achieved by pulling the dowel out of the hook in a radial direction (i.e., through the open mouth of the hook). Hook end 150 includes slots 156 to allow the strands of cable 118 to pass through the end of the connector.

Between attachment end 148 and hook end 150 of connector 144, a piston 158 is formed on or affixed to connector 144. Piston 158 may include any suitable structure configured to guide connector 144 as it travels axially inside of housing 142 of actuator portion 104. Housing 142 comprises a substantially cylindrical tube. Accordingly, piston 158 is substantially cylindrical. In some examples, such as the one depicted in FIG. 7, piston 158 may include side cutouts 160 to permit air to pass around the piston as it travels in the housing.

An opening or aperture 162 is formed in a second end 164 of housing 142. As depicted in FIG. 2, a rigid rod 166 or other tool may be inserted into aperture 162 and forced axially into housing 142 to extend spring 146 by pushing connector 144 toward first end 140. A latch mechanism 168 will then be used to hold the spring in the extended or cocked position until triggered. More specifically, latch mechanism 168 may include a latch hook 170 pivotably connected to a latch hook bracket 172 of trap 100. The hook end of latch hook 170 may pass through an opening in housing 142 to arrest the motion of connector 144, e.g., by abutting against piston 158. Pivoting latch hook 170 removes the hook end from the path of piston 158, thereby releasing the actuator to retract the noose.

Latch hook 170 may be held in position and selectively released using a solenoid-actuated mechanical stop 174 disposed adjacent to the non-hook end of latch hook 170. The latch hook may be biased toward a released position, such that repositioning of mechanical stop 174 frees the latch hook to pivot up and out of the aperture in housing 142. Solenoid actuation of the mechanical stop may be triggered by any suitable sensor (not shown), in communication with the solenoid and disposed adjacent to loop 120, as described with respect to FIG. 1.

Accordingly, the trap may be cocked by inserting rod 166 into aperture 162. Separately, or simultaneously, trapping portion 102 may be inserted into a space such as a tunnel, and loop 120 may be expanded to conform generally to the inner walls of the space. As described above, the loop of the noose will be generally transverse to the long axis of the extension guides, which may extend along an axis of the tunnel. If not already connected, the trapping portion and the cocked actuator may be connected by inserting the guides and cable into the corresponding connectors. When a small animal (e.g., a gopher) passes through the loop and triggers the sensor, the latch mechanism will be tripped, releasing the spring and rapidly contracting the loop around the body of the animal, thereby killing it. An operator may be notified, e.g., by visual inspection, by a mechanical indicator, or by a wireless signal from the trap. The noose portion may then be removed from the tunnel or burrow, and the animal disposed of. The trapping portion, or an element thereof, may be disposable or reusable. The trapping portion may be detached from the actuator portion before or after removal from the tunnel or burrow.

In summary, small animal traps, such as trap 100, may include an actuator portion that has a biasing mechanism (e.g., spring) with a connector at its terminal end (or other suitable location). A trapping portion of the trap may be coupled to the actuator portion, the trapping portion including an extension guide having a filament running through it. The filament is coupled to the connector of the biasing mechanism at a proximal end of the filament, forming a constrictable loop at a distal end. The trap includes a reorientation assembly comprising a pair of curved tubes coaxial with the filament and configured to reorient the filament such that the loop is generally transverse to the extension guide. In some examples, the trap further includes a wireless transmitter configured to communicate an actuation state of the trap to a receiving device. The receiving device may include a mobile phone. The actuation state of the trap may be displayable using an app on the mobile phone.

The extension guide may be substantially rigid in an axial dimension and substantially pliable in a non-axial dimension. The biasing mechanism may bias the constrictable loop toward a constricted configuration. A proximity sensor may be disposed adjacent the constrictable loop. The trap may further include a latch mechanism configured to hold the biasing mechanism in a cocked position and, in response to receiving a signal from the proximity sensor, to release the biasing mechanism.

In some examples, small animal traps may include an actuator portion including a spring coupled to a piston disposed in a substantially cylindrical housing, a trapping portion operatively coupled to the piston of the actuator portion, the trapping portion including an extension guide and a capture mechanism (e.g., noose or jaws) extending at a transverse (e.g., 90-degree) angle from the extension guide, such that the trapping portion is configured to extend along a tunnel with the capture mechanism extending at least partially across the tunnel. The capture mechanism may be operable between a cocked (or armed) configuration, in which the capture mechanism is expanded to substantially conform to a wall of the tunnel, and a triggered (or tripped) configuration, in which the capture mechanism is constricted by the actuator portion. The trap may further include a wireless transmitter configured to communicate to a receiving device information corresponding to whether the trap is in the cocked/armed configuration or the triggered/tripped configuration.

In examples where the capture mechanism includes a noose, the noose may have a filament coupled to the piston of the actuator and passing through the extension guide to form a loop. The extension guide may comprise a pair of bendable tubes coupled to the actuator portion. The trap may further include a latch configured to selectively resist movement of the piston along the housing. In some examples, the trap may further include a sensor disposed adjacent the capture mechanism and configured to communicate, to an actuator of the latch, the presence of a small animal within the capture mechanism.

A plurality of any of these traps may be in communication with a receiving device, the receiving device including a user interface for communicating the status of the plurality of traps to a user.

Network of Traps

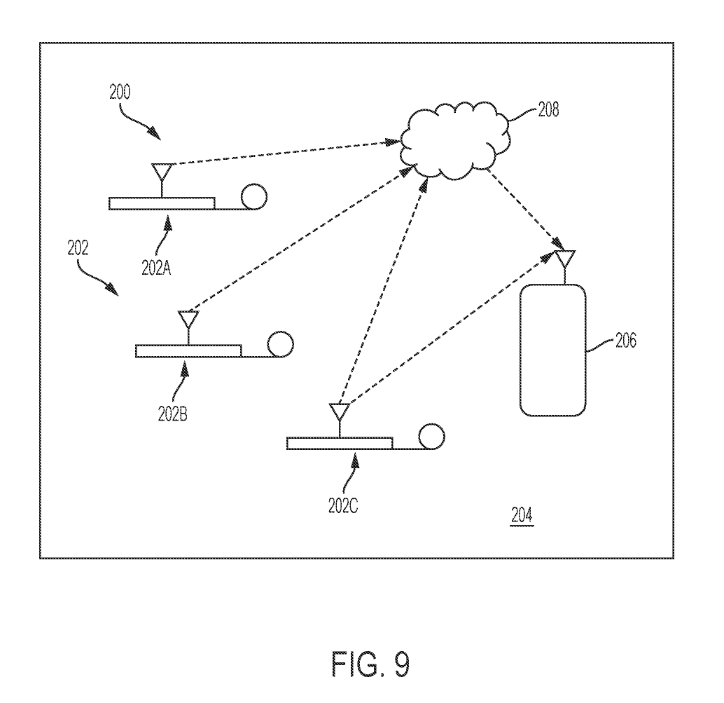

As shown in FIG. 9, this section describes an illustrative array 200 of small animal traps according to the present teachings. The traps in array 200 are examples of trap 100 or trap 10, described above. Accordingly, similar components may be labeled with similar reference numbers.

Array 200 may include a plurality of traps 202 deployed in a geographical area 204, traps 202 being substantially as described above with respect to traps 10 and/or 100. Any number of such traps may be deployed, as needed. For illustration, FIG. 9 depicts three traps, identified as trap 202A, 202B, and 202C.

As indicated in FIG. 9, each of the traps may communicate wirelessly with one or more remote receiving devices 206, either directly or through a network 208 (e.g., a data processing network, a cellular communications network, a local area network (LAN), the Internet, the “cloud,” or the like, or any combination of these). Receiving device 206 may include any suitable electronic device configured to receive and process the signals from one or more of traps 202, or configured to receive and display already-processed information from the traps. For example, receiving device 206 may include a laptop or desktop computer, a mobile computing device such as a smart phone or tablet, a dedicated receiver unit, a wearable device, and/or the like, or any combination of these.

In some examples, receiving device 206 may be in communication with network 208 (e.g., the Internet or a local area network (LAN)), in which another computer (e.g., a server) or combination of devices has received and processed the information communicated from traps 202. Network 208 may send processed information to receiving device 206, which may have an onboard application (app) configured to display the information. This display of information may include, for example, a map of the deployed traps and an indicator for each trap showing its actuation state (e.g., armed or tripped). In some examples, the trap may communicate directly, in point to point fashion, with receiving device 206, as indicated regarding trap 202C. Communications may be one-way (e.g., from the traps) or two-way (i.e., both from and to the traps).

Illustrative Method

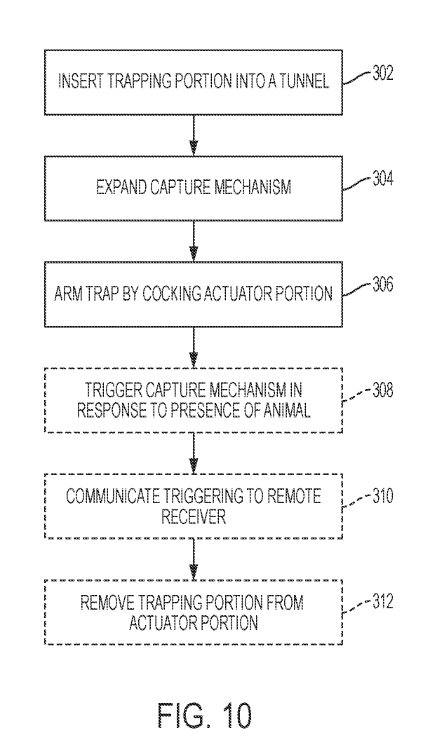

This section describes steps of an illustrative method for trapping a small animal, such as a gopher; see FIG. 10. Aspects of small animal traps described above may be utilized in the method steps described below. Where appropriate, reference may be made to previously described components and systems that may be used in carrying out each step. These references are for illustration, and are not intended to limit the possible ways of carrying out any particular step of the method.

FIG. 10 is a flowchart illustrating steps performed in an illustrative method, and may not recite the complete process or all steps of the method. FIG. 10 depicts multiple steps of a method, generally indicated at 300, which may be performed in conjunction with small animal traps according to aspects of the present disclosure. Although various steps of method 300 are described below and depicted in FIG. 10, the steps need not necessarily all be performed, and in some cases may be performed in a different order than the order shown.

Step 302 of method 300 includes inserting a trapping portion of a small animal trap into a tunnel and along a length of the tunnel, the trapping portion including an extension guide and a capture mechanism extending transversely from the extension guide. For example, trap 100 may be used, with trapping portion 102 having linear guides 106 and 108, and noose loop 120.

Step 304 of method 300 includes expanding the capture mechanism of the trapping portion (e.g., noose loop 120), such that the capture mechanism extends at least partially across the tunnel and conforms to the wall of the tunnel.

Step 306 of method 300 includes arming the small animal trap by cocking an actuator portion (e.g., actuator portion 104) coupled to the trapping portion. Cocking the actuator may include inserting a rod (e.g., rod 166) axially into a housing (e.g., housing 142) of the actuator and pushing a connector (e.g., connector 144) of the actuator against a biasing mechanism (e.g., spring 146) until the connector engages with a latch (e.g., a mechanical latch mechanism such as latch 168). In some examples, method 300 further includes holding the actuator portion in the cocked configuration using the mechanical latch mechanism.

Method 300 may continue with step 308, which includes triggering the capture mechanism in response to sensing a presence of an animal using an electronic sensor, thereby causing the capture mechanism to impinge upon the animal. In some examples, method 300 may include step 310, which includes communicating the triggering of the capture mechanism to a remote receiver using a wireless transmitter. In some examples, method 300 may include step 312, which includes removing the trapping portion from the actuator portion. Removing the trapping portion may include unbolting the trapping portion from the actuator portion. The trapping portion may be replaced with another, substantially identical trapping portion.

Additional Examples and Illustrative Combinations

This section describes additional aspects and features of small animal traps according to the present teachings, and related methods, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A0. A small animal trap comprising: an actuator portion including a biasing mechanism having a connector; a trapping portion coupled to the actuator portion, the trapping portion including an extension guide having a filament running therethrough, the filament being coupled to the connector of the biasing mechanism at a proximal end and forming a constrictable loop at a distal end; and a reorientation assembly including a pair of curved tubes coaxial with the filament and configured to reorient the filament such that the loop is generally transverse to the extension guide.

A1. The trap of A0, further including a wireless transmitter configured to communicate an actuation state of the trap to a receiving device.

A2. The trap of A1, wherein the receiving device is a mobile phone.

A3. The trap of A2, wherein the actuation state of the trap is displayable using an app on the mobile phone.

A4. The trap of any of paragraphs A0 through A3, wherein the extension guide is substantially rigid in an axial dimension and substantially pliable in a non-axial dimension.

A5. The trap of any of paragraphs A0 through A4, wherein the biasing mechanism comprises a spring, the constrictable loop being biased by the spring toward a constricted configuration.

A6. The trap of any of paragraphs A0 through A5, further comprising a proximity sensor adjacent the constrictable loop.

A7. The trap of A6, further comprising a latch mechanism configured to hold the biasing mechanism in a cocked position and, in response to receiving a signal from the proximity sensor, to release the biasing mechanism.

B0. A small animal trap comprising: an actuator portion including a spring coupled to a piston disposed in a substantially cylindrical housing; and a trapping portion operatively coupled to the piston of the actuator portion, the trapping portion including an extension guide and a capture mechanism extending at a transverse angle from the extension guide, such that the trapping portion is configured to extend along a tunnel with the capture mechanism extending at least partially across the tunnel; the capture mechanism being operable between a cocked configuration, in which the capture mechanism is expanded to substantially conform to a wall of the tunnel, and a triggered configuration, in which the capture mechanism is constricted by the actuator portion.

B1. The trap of B0, wherein the trap further includes a wireless transmitter configured to communicate to a receiving device information corresponding to whether the trap is in the cocked configuration or the triggered configuration.

B2. The trap of any of paragraphs B0 through B1, wherein the capture mechanism comprises a noose.

B3. The trap of B2, wherein the noose comprises a filament coupled to the piston of the actuator and passing through the extension guide to form a loop.

B4. The trap of any of paragraphs B0 through B3, wherein the extension guide comprises a pair of bendable tubes coupled to the actuator portion.

B5. The trap of any of paragraphs B0 through B4, further comprising a latch configured to selectively resist movement of the piston along the housing.

B6. The trap of B5, further comprising a sensor disposed adjacent the capture mechanism and configured to communicate, to an actuator of the latch, the presence of a small animal within the capture mechanism.

C0. A method for trapping a small animal, the method comprising: inserting a trapping portion of a small animal trap into a tunnel and along a length of the tunnel, the trapping portion including an extension guide and a capture mechanism extending transversely from the extension guide; expanding the capture mechanism of the trapping portion, such that the capture mechanism extends at least partially across the tunnel and conforms to the wall of the tunnel; and arming the small animal trap by cocking an actuator portion coupled to the trapping portion.

C1. The method of C0, further comprising holding the actuator portion in the cocked configuration using a mechanical latch mechanism.

C2. The method of any of paragraphs C0 through C1, further comprising triggering the capture mechanism in response to sensing a presence of an animal using an electronic sensor, thereby causing the capture mechanism to impinge upon the animal.

C3. The method of C2, further comprising communicating the triggering of the capture mechanism to a remote receiver using a wireless transmitter.

C4. The method of C2, further comprising clearing the trap by removing the animal from the capture mechanism.

C5. The method of C2, further comprising removing the trapping portion from the actuator portion.

C6. The method of C5, wherein removing the trapping portion includes unbolting the trapping portion from the actuator portion.

C7. The method of C5, further comprising replacing the trapping portion with another, substantially identical trapping portion.

C8. The method of any of paragraphs C0 through C7, wherein cocking the actuator includes inserting a rod axially into a housing of the actuator portion and pushing a connector of the actuator against a biasing mechanism until the connector engages with a latch.

C9. The method of C0, further including coupling the actuator portion to the trapping portion.

D0. A small animal trap comprising: a trapping portion including a capture mechanism configured to capture a target animal; an actuator portion coupled to the trapping portion and configured to actuate the capture mechanism; and a wireless transmitter configured to communicate an actuation state of the capture mechanism to a receiving device.

D1. The trap of D0, wherein the actuator portion includes a biasing mechanism having a connector; the trapping portion includes an extension guide having a filament running therethrough, the filament being coupled to the connector of the biasing mechanism at a proximal end and forming a constrictable loop at a distal end, and a reorientation assembly including a pair of curved tubes coaxial with the filament and configured to reorient the filament such that the loop is generally transverse to the extension guide.

D2. The trap of any of paragraphs D0 through D1, wherein the capture mechanism is configured to fit within and laterally conform to an underground tunnel of the target animal.

D3. The trap of any of paragraphs D0 through D2, further comprising: a proximity sensor adjacent the capture mechanism; and a latch mechanism configured to hold a biasing mechanism of the actuator in a cocked position and, in response to receiving a signal from the proximity sensor, to release the biasing mechanism.

D4. The trap of any of paragraphs D0 through D3, wherein the wireless transmitter is configured to communicate the actuation state of the capture mechanism to the receiving device through a network.

E0. An array of small animal traps, the array comprising:

a plurality of the traps of paragraphs A0, B0, or C0, each of the traps being in communication with a receiving device, the receiving device including a user interface for communicating the status of the plurality of traps to a user.

Conclusion

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the invention(s) includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

What is claimed is:

1. A small animal trap comprising:
an actuator portion including a biasing mechanism having a connector;
a trapping portion coupled to the actuator portion, the trapping portion including an extension guide having a filament running therethrough, the filament being coupled to the connector of the biasing mechanism at a proximal end and forming a constrictable loop at a distal end; and
a reorientation assembly including a pair of curved tubes coaxial with the filament and configured to reorient the filament such that the loop is generally transverse to the extension guide.

2. The trap of claim 1, further including a wireless transmitter configured to communicate an actuation state of the trap to a receiving device.

3. The trap of claim 2, wherein the receiving device is a mobile phone.

4. The trap of claim 3, wherein the actuation state of the trap is displayable using an app on the mobile phone.

5. The trap of claim 1, wherein the extension guide is substantially rigid in an axial dimension and substantially pliable in a non-axial dimension.

6. The trap of claim 1, further comprising a proximity sensor adjacent the constrictable loop.

7. The trap of claim 6, further comprising a latch mechanism configured to hold the biasing mechanism in a cocked position and, in response to receiving a signal from the proximity sensor, to release the biasing mechanism.

8. A small animal trap comprising:
an actuator portion including a spring coupled to a piston disposed in a substantially cylindrical housing; and
a trapping portion operatively coupled to the piston of the actuator portion, the trapping portion including an extension guide and a capture mechanism extending at a transverse angle from the extension guide, such that the trapping portion is configured to extend along a tunnel with the capture mechanism extending at least partially across the tunnel;
the capture mechanism being operable between a cocked configuration, in which the capture mechanism is expanded to substantially conform to a wall of the tunnel, and a triggered configuration, in which the capture mechanism is constricted by the actuator portion.

9. The trap of claim 8, wherein the trap further includes a wireless transmitter configured to communicate to a receiving device information corresponding to whether the trap is in the cocked configuration or the triggered configuration.

10. The trap of claim 8, wherein the capture mechanism comprises a noose.

11. The trap of claim 8, wherein the extension guide comprises a pair of bendable tubes coupled to the actuator portion.

12. The trap of claim 8, further comprising a latch configured to selectively resist movement of the piston along the housing.

13. The trap of claim 12, further comprising a sensor disposed adjacent the capture mechanism and configured to communicate, to an actuator of the latch, the presence of a small animal within the capture mechanism.

14. A method for trapping a small animal, the method comprising:
inserting a trapping portion of a small animal trap into a tunnel and along a length of the tunnel, the trapping portion including an extension guide and a capture mechanism extending transversely from the extension guide;
expanding the capture mechanism of the trapping portion, such that the capture mechanism extends at least partially across the tunnel and conforms to the wall of the tunnel; and
arming the small animal trap by cocking an actuator portion coupled to the trapping portion.

15. The method of claim 14, further comprising holding the actuator portion in the cocked configuration using a mechanical latch mechanism.

16. The method of claim 14, further comprising triggering the capture mechanism in response to sensing a presence of an animal using an electronic sensor, thereby causing the capture mechanism to impinge upon the animal.

17. The method of claim 16, further comprising communicating the triggering of the capture mechanism to a remote receiver using a wireless transmitter.

18. The method of claim 16, further comprising removing the trapping portion from the actuator portion.

19. The method of claim 18, further comprising replacing the trapping portion with another, substantially identical trapping portion.

20. The method of claim 14, wherein cocking the actuator includes inserting a rod axially into the cylindrical housing and pushing a connector of the actuator against a biasing mechanism until the connector engages with a latch.

21. A small animal trap comprising:
a trapping portion including a capture mechanism configured to capture a target animal;
an actuator portion coupled to the trapping portion and configured to actuate the capture mechanism; and
a wireless transmitter configured to communicate an actuation state of the capture mechanism to a receiving device.

22. The trap of claim 21, wherein the actuator portion includes a biasing mechanism having a connector; and
the trapping portion includes an extension guide having a filament running therethrough, the filament being coupled to the connector of the biasing mechanism at a proximal end and forming a constrictable loop at a distal end, and a reorientation assembly including a pair of curved tubes coaxial with the filament and configured to reorient the filament such that the loop is generally transverse to the extension guide.

23. The trap of claim 21, wherein the capture mechanism is configured to fit within and laterally conform to an underground tunnel of the target animal.

24. The trap of claim 21, further comprising:
a proximity sensor adjacent the capture mechanism; and
a latch mechanism configured to hold a biasing mechanism of the actuator in a cocked position and, in response to receiving a signal from the proximity sensor, to release the biasing mechanism.

25. The trap of claim 21, wherein the wireless transmitter is configured to communicate the actuation state of the capture mechanism to the receiving device through a network.
